(19) United States
(12) Patent Application Publication
(10) Pub. No.: US 2014/0277927 A1
(43) Pub. Date: Sep. 18, 2014

(54) FUEL CONSUMPTION COMPENSATION FOR EVAPORATIVE EMISSIONS SYSTEM LEAK DETECTION METHODS

(71) Applicant: DELPHI TECHNOLOGIES, INC., Troy, MI (US)

(72) Inventors: YICHAO GUO, AUBURN HILLS, MI (US); KENNETH M. SIMPSON, SWARTZ CREEK, MI (US); JAMES W. JEFFERS, LINDEN, MI (US)

(73) Assignee: DELPHI TECHNOLOGIES, INC., TROY, MI (US)

(21) Appl. No.: 13/803,954

(22) Filed: Mar. 14, 2013

(51) Int. Cl. F02M 25/08

(52) U.S. Cl. CPC F02M 25/0818
USPC 701/34.4

(57) ABSTRACT

A method for monitoring an evaporative emissions control (EVAP) system that includes compensating a diagnostic leakage test based on a fuel consumption amount during a test interval is disclosed. The method includes establishing a leak test pressure in the EVAP system, operating the operating the associated valves and pumps such that the EVAP system is expected to be isolated, determining an actual pressure change of the EVAP system, determining an expected pressure change of the EVAP system based on vehicle operating conditions that include the fuel consumption amount, and indicating that a leak is detected if the actual pressure change differs from the expected pressure change by more than a difference threshold.

### TECHNICAL FIELD OF INVENTION

This disclosure generally relates to detecting leaks in a vehicle evaporative emissions control (EVAP) system, and more particularly relates to compensating the threshold used to detect a leak for the effects of fuel consumption during an EVAP system diagnostic test.

### BACKGROUND OF INVENTION

Government regulations require that vehicles be configured to perform self-diagnostic testing of the evaporative emissions control (EVAP) system on the vehicle. Typically, the pressure inside the EVAP system, which is indicated by a pressure sensor that is typically mounted inside the fuel tank (i.e., EVAP system pressure), is changed to a predetermined leak test pressure that is less than or greater than atmospheric pressure by either vacuum from a running engine, a pressure pump, or a vacuum pump to create certain conditions in the EVAP system so diagnostic testing can be performed. One regulation requires that a leak equivalent to a 0.5 millimeter (mm) hole be detected. After the predetermined leak test pressure (i.e.—pressure value) is established, the EVAP system is isolated by closing both the purge valve and the canister vent valve, and the pressure value is then monitored for a change indicative of a leak. If a leak exists, the pressure value will approach the atmospheric pressure over time due to the gas communication through the leak in the EVAP system. Known EVAP systems take into account some factors that influence tank pressure during monitoring, but not all factors. Some of the known factors that may influence the tank pressure during monitoring include fuel volatility, temperature, road vibration, and fuel slosh. The engine's consumption of fuel from the fuel tank may influence the pressure of the EVAP system. Compensation for the fuel consumption effect enhances the leakage diagnostic's ability to distinguish between acceptable leakage (e.g., <0.5 mm hole) and unacceptable leakage (e.g., >=0.5 mm hole).

### SUMMARY OF THE INVENTION

In accordance with one embodiment, a method for monitoring an evaporative emissions control (EVAP) system is provided. The method includes compensating a diagnostic test of the EVAP system based on a fuel consumption amount during a test interval.

In accordance with one embodiment, a method for monitoring an EVAP system in a vehicle is provided. The system includes a fuel tank. The system also includes a vent valve operable to an open state that allows fluidic communication through the vent valve between the EVAP system and atmosphere, and a closed state that blocks fluidic communication through the vent valve. The system also includes a purge valve operable to an open state that allows fluidic communication through the purge valve between the EVAP system and the intake manifold of the engine, and a closed state that blocks fluidic communication through the purge valve. The method includes the step of establishing a leak test pressure in the EVAP system. The method also includes the step of operating the vent valve and the purge valve to the closed state. The method also includes the step of determining an actual pressure change of the EVAP system. The method also includes the step of determining an expected pressure change in the EVAP system based on vehicle operating conditions that include the fuel consumption amount. The method also includes the step of indicating that a leak is detected if the actual pressure change differs from the expected pressure change by more than a difference threshold.

In accordance with one embodiment, a method of detecting a leak of an EVAP system in a vehicle is provided. The EVAP system includes a fuel tank. The EVAP system also includes a vent valve operable to an open state that allows fluidic communication through the vent valve between the EVAP system and atmosphere, and a closed state that blocks fluidic communication through the vent valve. The system also includes a purge valve operable to an open state that allows fluidic communication through the purge valve between the EVAP system and the intake manifold of the engine, and a closed state that blocks fluidic communication through the purge valve. The method includes the step of reducing EVAP system pressure to a leak test pressure less than atmospheric pressure. The method also includes the step of operating the vent valve and the purge valve to the closed state. The method also includes the step of determining an actual pressure increase of the EVAP system. The method also includes the step of determining an expected pressure change based on vehicle operating conditions that include a fuel consumption amount. The method also includes the step of indicating that a leak is detected if the actual pressure increase is greater than the expected pressure increase.

In accordance with one embodiment, a method of detecting a leak of an EVAP system in a vehicle is provided. The EVAP system includes a fuel tank. The EVAP system also includes a vent valve operable to an open state that allows fluidic communication through the vent valve between the EVAP system and atmosphere, and a closed state that blocks fluidic communication through the vent valve. The EVAP system also includes a purge valve operable to an open state that allows fluidic communication through the purge valve between the EVAP system and the intake manifold of the engine, and a closed state that blocks fluidic communication through the purge valve. The method includes the step of reducing EVAP system pressure to a leak test pressure less than atmospheric pressure. The method also includes the step of operating the vent valve and the purge valve to the closed state. The method also includes the step of determining an actual pressure increase rate of the EVAP system pressure. The method also includes the step of determining an expected pressure change rate based on vehicle operating conditions that include a fuel consumption rate. The method also includes the step of indicating that a leak is detected if the actual pressure increase rate is greater than the expected increase rate.

In accordance with one embodiment, a method of detecting a leak of an evaporative emissions system coupled to a fuel tank in a vehicle is provided. The system includes a vent valve operable to an open state that allows fluidic communication through the vent valve between the fuel tank and atmospheric pressure, and a closed state that blocks fluidic communication through the vent valve. The system also includes a purge valve operable to an open state that allows fluidic communication through the purge valve between the fuel tank and engine vacuum, and a closed state that blocks fluidic communication through the purge valve. The method includes the step of reducing EVAP system pressure to a leak test pressure less than atmospheric pressure. The method also includes the step of operating the vent valve and the purge valve to the closed state. The method also includes the step of determining an actual pressure increase rate of the EVAP system pressure. The method also includes the step of determining an expected pressure increase rate based on vehicle operating conditions that include a fuel consumption rate. The method also includes the step of indicating that a leak is detected if the actual pressure increase rate is greater than the expected increase rate.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of an evaporative emissions (EVAP) system in accordance with one embodiment;

FIG. 2 is flowchart of a method of operating the system of FIG. 1 in accordance with one embodiment;

FIG. 3 is flowchart of a method of operating the system of FIG. 1 in accordance with one embodiment;

FIG. 4 is flowchart of a method of operating the system of FIG. 1 in accordance with one embodiment; and

FIGS. 5A and 5B combined form a flowchart of a method of operating the system of FIG. 1 in accordance with one embodiment.

### DETAILED DESCRIPTION

While investigating ways to improve the prediction of the change of EVAP system pressure during a leak test, it was discovered that fuel consumption may be a dominate cause of change in the EVAP system pressure. The terms ‘EVAP system pressure’, ‘(fuel) tank pressure’, ‘EVAP system vacuum’, and ‘(fuel) tank vacuum’ may be used interchangeable throughout the following description. The terms ‘EVAP system pressure’, ‘tank pressure’, ‘fuel tank vacuum’, and ‘tank vacuum’ may be used interchangeable throughout the following description. In some instances ‘pressure’ is use to indicate an absolute pressure or gauge pressure, while ‘vacuum’ is generally used to indicate a pressure difference between atmospheric pressure outside the EVAP system and a reduced pressure relative to the atmospheric pressure present within the EVAP system.

Known EVAP systems often wait for engine idle/vehicle not moving conditions to perform tests of the EVAP system. However, because some vehicle are configured so that engines are turned off automatically when, for example, the vehicle operator is waiting for a traffic light to change from red to green, more aggressive EVAP system test strategies are necessary that perform EVAP system tests while the vehicle is moving. Fuel consumption when vehicle idling is typically low enough that is can be ignored during an EVAP system test. However, when the vehicle is moving, fuel consumption may be sufficient to have a discernible effect on EVAP system pressure while the EVAP system is isolated by closing both the purge valve and the canister vent valve.

FIG. 1 illustrates a non-limiting example of a vehicle, illustrated here as a box, and hereafter often referred to as the vehicle 10. The vehicle 10 may be, for example, an automobile or a truck, as will be recognized by those skilled in the transportation arts. However, the teachings presented herein may also be used for stationary power generating or pumping facilities. In general, the vehicle 10 is equipped with an engine 12, and an evaporative emissions (EVAP) system, hereafter often referred to as the EVAP system 14. The vehicle 10 may include an engine control module (ECM) or engine controller, hereafter often referred to as the controller 16. The controller 16 may include a processor (not shown) such as a microprocessor or other control circuitry as should be evident to those in the art. The controller 16 may include memory, including non-volatile memory, such as electrically erasable programmable read-only memory (EEPROM) for storing one or more routines, thresholds and captured data. The one or more routines may be executed by the processor to perform steps for determining signals sent and received by the controller 16 for operating the engine 12 and the EVAP system 14 as described herein.

Many of the details illustrated in FIG. 1 are commonly found in typical EVAP systems, and are only shown for the purpose of explanation and not a limitation. Furthermore, it is recognized that the EVAP system 14 may include additional features not shown in FIG. 1. The EVAP system 14 includes a fuel tank 18 for storing fuel to run the engine 12. While not subscribing to any particular theory, fuels such as gasoline evaporate, and evaporated gasoline has been deemed an undesirable pollutant. Accordingly, a canister 20 is provided to capture and store fuel vapors until a time when the canister 20 can be purged by the engine 12 drawing fuel vapors out of the canister 20, and allowing the canister 20 to be replenished with fresh air. The EVAP system 14 includes a purge valve 22 configured to be operated by the controller 16 to regulate purge flow 24 into the engine 12. It will be recognized by those skilled in the art that the purge flow 24 is also influenced by the amount of vacuum generated by the engine 12 at a purge port 26, illustrated here as being downstream of a throttle plate of a throttle body 28.

The EVAP system 14 may also include a vent valve 30 operated by the controller 16 to regulate the amount of vent air 32 or filtered fresh air entering the canister 20. The system also includes a fuel fill inlet 34 so the fuel tank 18 can be refilled, and a fuel cap 36 that, when properly installed, seals the fuel tank so fuel vapors cannot escape to the environment via the flue fill inlet 34. In the description that follows, it is assumed that the fuel cap 36 has been properly installed. The EVAP system 14 may also include a vacuum sensor 38 configured to determine a vacuum value 40 in the fuel tank 18, and communicate the vacuum value 40 to the controller 16.

By way of example and not limitation, the purge valve 22 and the vent valve 30 may both be operated to an open state so a vacuum pressure from the engine 12 can be used to purge fuel or fuel vapors from the canister. Alternatively, the vent valve 30 may be operated to a closed state while the purge valve 22 is operated to an open state and the engine 12 is generating a vacuum pressure so that an EVAP system pressure can be established in the canister 20 and in the fuel tank 18. Then, once a predetermined EVAP system pressure is established in the EVAP system, both the vent valve 30 and the purge valve 22 may be operated to a closed state and the EVAP system pressure indicated by the vacuum value 40 should persist for at least a brief period. As will become apparent in the description that follows, the rate at which the vacuum value 40 changes, or the amount that the vacuum value 40 changes over a time interval after the EVAP system pressure is established and both valves are closed is indicative of a leak size of a leak somewhere in the EVAP system 14.

The EVAP system 14 may optionally include a first pump 42 configured to pressurize the EVAP system to an EVAP system pressure greater than atmospheric pressure. Suitable pumps are commercially available, and the operation of the first pump 42 is further described in U.S. Pat. No. 5,390,645 to Cook et al., issued Feb. 21, 1995. The non-limiting example of FIG. 1 illustrates the first pump 42 as being connected in series with the vent valve 30, and so it should be recognized the vent valve 30 would need to be operated to the open state for the first pump 42 to be able to pressurize the EVAP system, including the canister 20 and the fuel tank 18, if the connection between the canister 20 and the fuel tank 18 is not otherwise blocked. Alternatively, the first pump may be coupled to the canister 20 in a manner that bypasses the vent valve. For this configuration, it is preferable that the first pump 42 be a type of pump that blocks flow through the first pump 42 if the pump is not being operated.

The EVAP system 14 may optionally include a second pump 44 configured to reduce the EVAP system pressure to less than atmospheric pressure. By including the second pump 44, the EVAP system 14 is able to reduce the EVAP system pressure in order to perform diagnostic testing even if the engine vacuum present at the purge port 26 is inadequate to reduce the EVAP system pressure to a desired test pressure. Inadequate engine vacuum may occur if the engine 12 is operating off-idle. Suitable pumps are commercially available, and the operation of the second pump 44 is further described in U.S. Pat. No. 5,715,799 to Blomquist et al., issued Feb. 10, 1998.

Table 1 below shows a non-limiting example of the expected effect on EVAP system pressure of a sealed EVAP system, including the fuel tank by fuel consumption of a wide-open-throttle (WOT) engine. This shows how fuel consumption could be the dominating reason of a change or rate of change of EVAP system pressure during the EVAP system tests that may cause false fails/passes of EVAP system diagnostics.

TABLE 1

| Parameter List | | | Description |
|---|---|---|---|
| Total volume in EVAP | 70 | L | |
| system | | | |
| Fuel amount(Full fueling | 60 | L | |
| base) | | | |
| Vapor volume in EVAP | 10 | L | |
| system | | | |
| Average Intake air flow at | 140 | gram/sec | Desired fuel efficiency ratio = |
| wide-open-throttle (WOT) | | | 14 |
| Rate of volume change by | 0.0135 | L/sec | Fuel density = 740 g/L |
| fuel consumption | | | |
| WOT time | 40 | sec | |
| Amount of fuel volume | 0.54 | L | Change of fuel tank volume |
| change on tank during WOT | | | ignore, Assuming to Leak = 0. |
| Expected final EVAP system | 94.9 | kPa | P1 * V1/T1 = P2 * V2/T2, Initial |
| pressure | | | EVAP system |
| | | | pressure = 100 kPa, Change |
| | | | of fuel tank volume ignore, |
| | | | Assuming to Leak = 0 |
| Expected pressure change | 94.9 − | kPa | The reduced fuel volume |
| in EVAP system | 100 = | | creates 5.1 kPa vacuum in |
| | −5.1 | | the EVAP system. |

During a purge leak test, both the purge valve 22 and the vent value 30 are closed. The test period for the purge valve leak test may be, for example, one hundred seconds (100 s). The fail threshold for this test is a function of fuel level, and it varies from 0.5 to 1.5 kPa less than the atmospheric pressure. If the EVAP system pressure during the test changes more than expected, a failure of the test is indicated. Because the EVAP system pressure could easily be drawn to a pressure that is 2.5 kPa less than the atmosphere pressure in 40 seconds of wide-open-throttle engine condition, a false fail may be trigged by increased tank vacuum due to the reduced fuel volume caused by the engine fuel consumption.

During a vacuum-decay small/very small leak test, both the purge valve and the vent value are closed as well. The test period may be 40 seconds. If the tank vacuum drops (i.e. EVAP system pressure increases) more than expected, a failure of the test will be indicated.

For a system with very small/small leakage, the amount of the tank vacuum drop (i.e. EVAP system pressure increase) and the associated slope could be greatly reduced by the engine fuel consumption or even become negative with wide-open-throttle engine conditions. Thus, the vacuum-decay leak tests for a leaky system could be falsely reported as a pass, or be aborted due to the convex tank vacuum curve.

FIG. 2 illustrates a non-limiting example of a method 200 of detecting a leak of an evaporative emissions system (the EVAP system 14) in a vehicle 10. The EVAP system 14 includes a vent valve 30 operable to an open state that allows fluidic communication through the vent valve 30 between the EVAP system 14 and atmospheric pressure, and a closed state that blocks fluidic communication through the vent valve 30, in particular blocks vent air 32 from entering a canister 20. The EVAP system 14 also includes a purge valve 22 operable to an open state that allows fluidic communication through the purge valve 22 between the EVAP system 14 and engine vacuum, and a closed state that blocks fluidic communication through the purge valve 22. Engine vacuum may be provided by way of a purge port 26 of a throttle body 28 coupled to the engine 12.

Step 210, INITIATE PURGE TEST, may include the controller 16 monitoring the operation of the engine 12 to detect an operating condition favorable to performing a diagnostic test of the EVAP system 14. For example, if an extended period of steady operation (i.e. a relatively constant engine load and engine speed) is expected, then conditions may be suitable to perform a diagnostic test of the EVAP system 14.

Step 220, OPEN PURGE VALVE, may include the controller 16 outputting a control signal to the purge valve 22 effective to operate the purge valve 22 to the open state. Alternatively, the controller 16 may output a pulse width modulated signal that rapidly opens and closes the purge valve to control the purge flow 24 to some value less than would be the case if the purge valve 22 were simply held in the open state.

Step 230, CLOSE VENT VALVE, may include the controller 16 outputting a control signal to the vent valve 30 effective to operate the purge valve 22 to the closed state. By way of example and not limitation, if the vent valve 30 were equipped with a spring configured to urge the vent valve 30 to the closed state in the absence of a control signal, operating the vent valve 30 to the closed state may merely require turning off any control signal output by the controller 16.

The combination of step 220 and step 230 cooperate to reduce EVAP system pressure by subjecting the fuel tank 18 (via the canister 20) to engine vacuum from the engine 12 to establish a leak test pressure less than atmospheric pressure.

Step 240, TANK PRESSURE>TEST PRESSURE?, may include the controller monitoring the vacuum value 40 output by the vacuum sensor 38. If the tank vacuum is not great enough, i.e. the tank pressure greater than a desired test pressure, then decision block at step 240 follows the YES logic path and so the purge valve 22 continues to remain open. Once a sufficient vacuum is established, i.e. the tank pressure is less than the desired test pressure, then the NO logic path is followed to step 250.

Step 250, CLOSE PURGE VALVE, may include operating the vent valve 30 and the purge valve 22 to the closed state. Since the vent valve 30 was already closed in step 230, it may only be necessary to close the purge valve 22.

Step 260, DETERMINE ACTUAL PRESSURE INCREASE, may include determining an actual pressure increase of the EVAP system pressure over a time interval. Alternatively, step 260 may include determining an actual pressure increase rate of the EVAP system pressure, that is determine a slope value indicative of rate of change of EVAP system pressure.

Step 270, DETERMINE EXPECTED PRESSURE INCREASE, may include determining an expected pressure increase based on vehicle operating conditions that include a fuel consumption amount. Alternatively, step 270 may include determining an expected pressure increase rate of the EVAP system pressure, that is determine a slope value indicative of an expected rate of change of EVAP system pressure. In general, an increase in tank pressure (i.e. a decrease in tank vacuum) is expected due to fuel evaporation and leaks if present. Various factors such as fuel volatility, temperature, road vibration, and fuel slosh have been suggested as factors that can influence an expected pressure increase or expected pressure increase rate. However, it was discovered that the fuel consumption amount or fuel consumption rate can have a discernible effect on expected pressure increase or expected pressure increase rate, as described above with regard to Table 1, and described in further detail below with regard to FIGS. 3 and 4. In general, fuel consumption is expected to decrease tank pressure (i.e. increase tank vacuum) because fuel removed by fuel consumption is not replaced with fresh air (or fuel vapors from the canister 20) as the vent valve 30 is closed.

Step 280, ACTUAL PRESSURE INCREASE>EXPECTED PRESSURE INCREASE?, may include the controller 16 comparing the actual pressure increase determine in step 260 to the expected pressure increase determined in step 270. If the actual pressure increase is greater than the expected pressure increase, the YES logic path is followed to step 290. If the actual pressure increase is not greater than the expected pressure increase, the NO logic path is followed to step 299.

Step 290, INDICATE LEAK DETECTED, may include indicating that a leak is detected if the actual pressure decrease is greater than the expected pressure decrease by the controller 16 illuminating a warning light, or recording a fault code in the controller 16.

Step 299, EXIT PURGE TEST, may include the controller 16 recording in a data log that a purge diagnostic test was completed.

FIG. 3 illustrates a non-limiting example of a method 300 that illustrates in more detail operations that may be carried out in steps 270, 280, and 290 described above. In method 300, Threshold B that takes the engine fuel consumption into account, when the tank vacuum during a purge value leak test exceeds the threshold that has not been compensated by the fuel consumption (Threshold A). Table 2 lists variables used in Eqs. 1-5 that may be calculated to determine Threshold B.

TABLE 2
Parameters

| | | |
|---|---|---|
| Total volume in EVAP | V_tot | L |
| system | | |
| Fuel amount before the | V_1 | L |
| Purge Leak Test | | |
| Vapor volume in EVAP | V_vap1 | L |
| system before the Purge | | |
| Leak Test | | |
| Actual EVAP system | P1 | KPa |
| pressure at the | | |
| beginning of Purge Leak | | |
| Test | | |
| Purge Leak Test time | t_purg | sec |
| Amount of accumulated | V_fuel | L |
| fuel that is consumed by | | |
| the engine during the | | |
| Purge Leak Test | | |
| Vapor volume in EVAP | V_vap2 | L |
| system at the end of the | | |
| Purge Leak Test | | |
| Ideal EVAP system | P2 | kPa |
| pressure at the end of | | |
| Purge Leak Test due to | | |
| the change of Vapor | | |
| Volume caused by fuel | | |
| consumption | | |
| Actual EVAP system | P_End | KPa |
| vacuum reading at the | | |
| end of purge valve leak | | |
| test | | |

V_vap1=V_tot−V_{—}1 Eq. 1

V_vap2=V_tot−V_{—}1+V_fuel Eq. 2

P1*V_vap1=P2*V_vap2 Eq. 3

Insertion of Eq. 1 and Eq. 2 into Eq. 3 yields

P2=P1*(V_tot−V_{—}1)/(V_tot−V_{—}1+V_fuel) Eq. 4

Then,

Threshold B=Threshold A+(P1−P2)=Threshold A+P1*V_fuel/(V_tot−V_{—}1+V_fuel) Eq. 5

When the tank vacuum (i.e. —EVAP system vacuum) at the end of purge-valve leak test exceeds Threshold B, a fail should be reported. When the tank vacuum increase caused by the fuel consumption is the dominating reason of the vacuum increase during the test (that is, Threshold C1=<(P1−P_End)/(Threshold B−Threshold A)<=Threshold C2), a pass report of purge valve leak test should be generated. Otherwise, no pass/fail decision can be made for the current test. Note: according to Eq. (4), (P1−P_End)/(Threshold B−Threshold A) is identical to (P1−P_End)/(P1−P2). It is the ratio of the actual pressure change in the EVAP system over the ideal pressure change caused by the consumed fuel, and it is the direct measurement of the impact of the fuel volume change on the tank vacuum. If the actual pressure change in the EVAP system is very close to the ideal pressure change caused by the consumed fuel (e.g., Threshold C1=90%, and Threshold C2=110%), the purge valve leak test should pass even if the raw test result fails (the tank vacuum at the end of the test exceed Threshold A), because the tank vacuum in the EVAP system is mainly caused by the fuel consumption.

FIG. 4 illustrates a non-limiting example of a method 400 for taking into account the fuel consumption during the vacuum decay test interval that illustrates in more detail operations that may be carried out in steps 270, 280, and 290 described above. Threshold E and Threshold F are the existing vacuum decay slope thresholds for very small and small leak tests, respectively. The final vacuum slope D that takes into account both the fuel consumption and the vapor generation inside the EVAP system during the vacuum decay test is the relevant. The parameters to calculate the final vacuum Slope D are listed in Table 3 and used in Eqs. 6 and 7 below.

TABLE 3
Parameters

| | | |
|---|---|---|
| Total volume in EVAP | V_tot | L |
| system | | |
| Fuel amount before the | V_3 | L |
| Vacuum-decay Leak | | |
| Tests | | |
| Vapor volume in EVAP | V_vap3 | L |
| system before the | | |
| Vacuum-decay Leak | | |
| Tests | | |
| EVAP system pressure | P3 | KPa |
| measured at the | | |
| beginning of Vacuum- | | |
| decay Leak Tests | | |
| Vacuum-decay Leak | t_vac | sec |
| Test time | | |
| Amount of accumulated | V_fuel2 | L |
| fuel that is consumed by | | |
| the engine during the | | |
| Vacuum-decay Leak | | |
| Tests | | |
| Vapor volume in EVAP | V_vap4 | L |
| system at the end of the | | |
| Vacuum-decay Leak | | |
| Tests | | |
| Ideal EVAP system | P4 | KPa |
| pressure at the end of | | |
| Vacuum-decay Leak | | |
| Tests due to the change | | |
| of Vapor Volume caused | | |
| by fuel consumption | | |
| EVAP system pressure | P5 | KPa |
| measured at the end of | | |
| Vacuum-decay Leak | | |
| Tests | | |
| Pressure increase | Delta_P | KPa |
| caused by vapor | | |
| generation during the | | |
| test | | |

Similar to the previous example, utilization of the ideal gas law yields the Ideal EVAP system pressure at the end of Vacuum-decay Leak Tests due to the change of Vapor Volume caused by fuel consumption P4 as

P4=P3*(V_tot−V_{—}3)/(V_tot−V_{—}3+V_fuel) Eq. 6

Then the final vacuum slope D is:

$$\begin{matrix}Vacumn slope D = [ ( P 3 - P 5 ) - ( P 3 - P 4 ) - Delta\_P ] / t\_vac \\ = ( P 4 - P 5 - Delta\_P ) / t\_vac\end{matrix}$$

Comparing the final vacuum slope D with the Threshold E and Threshold F of small and very small leak tests will provide accurate test results for the vacuum decay tests for evaporative systems.

FIGS. 5A and 5B combined illustrate a non-limiting example of a method 500 of detecting a leak of an evaporative emissions system (the EVAP system 14) in a vehicle 10. The EVAP system 14 includes a vent valve 30 operable to an open state that allows fluidic communication through the vent valve 30 between the fuel tank 18 and atmospheric pressure, and a closed state that blocks fluidic communication through the vent valve 30, in particular blocks vent air 32 from entering a canister 20. The EVAP system 14 also includes a purge valve 22 operable to an open state that allows fluidic communication through the purge valve 22 between the fuel tank 18 and engine vacuum, and a closed state that blocks fluidic communication through the purge valve 22. Engine vacuum may be provided by way of a purge port 26 of a throttle body 28 coupled to the engine 12. The EVAP system 14 may optionally include a first pump 42 and/or a second pump 44 configured as shown on FIG. 1.

It should be appreciated that if the EVAP system 14 does not include one, or the other, or both of the pumps, the pumps would typically be replaced by vent hose. As such, if the first pump 42 is not present, the vent valve 30 is preferably directly coupled to the atmosphere. Similarly, if the second pump 44 is not present, the canister 20 is directly coupled to the purge valve 22, and so it is expected that the pressure in the canister 20 is the same as the pressure at the EVAP system side of the purge valve 22. Accordingly, the method 500 must know or determine the configuration of the EVAP system 14 so that the valves and optional pumps present are suitably utilized.

Step 502, EQUIPPED WITH SECOND PUMP?, may include the controller 16 determining if the second pump 44 is present. This determination may be by the controller 16 sensing a voltage on a wired connection (not shown) between the controller 16 and the second pump 44, or by examining a calibration variable stored in the controller 16 that indicates the configuration of the EVAP system 14. If YES, the method 500 proceeds to step 530 where the operation of a system equipped with the second pump 44 is described. If NO, the method 500 proceeds to step 504.

Step 504, EQUIPPED WITH FIRST PUMP?, may include the controller 16 determining if the first pump 42 is present. This determination may be by the controller 16 sensing a voltage on a wired connection (not shown) between the controller 16 and the first pump 42, or by examining a calibration variable stored in the controller 16 that indicates the configuration of the EVAP system 14. If YES, the method 500 proceeds to step 520 where the operation of a system equipped with the first pump 42 is described. If NO, the method 500 proceeds to step 510. Steps 510, 512, and 516 are executed if the EVAP system 14 is not equipped with the first pump 42 and is not equipped with the second pump 44.

Step 510, CLOSE VENT VALVE, may include the controller 16 sending a signal to the vent valve 30 effective to operate the vent valve 30 to the closed state.

Step 512, OPEN PURGE VALVE, may include the controller 16 sending a signal to the purge valve 22 effective to operate the purge valve 22 to the open state.

Step 516, LEAK TEST PRESSURE ESTABLISHED?, may include the controller 16 monitoring the vacuum value 40 indicated by the vacuum sensor 38 until the EVAP system pressure is reduced to a value suitable for leak testing the EVAP system 14. If the EVAP system includes neither the first pump 42 nor the second pump 44, then engine vacuum provided by the engine 12 is relied upon to reduce the EVAP system pressure to a value suitable for leak testing. If NO, the vent valve 30 and the purge valve 22 are maintained in the designated states until a suitable EVAP system pressure value is established. If YES, the method 500 proceeds to step 540.

Steps 520, 522, 524, and 526 are executed if the EVAP system 14 is equipped with the first pump 44.

Step 520, CLOSE PURGE VALVE, may include the controller 16 sending a signal to the purge valve 22 effective to operate the purge valve 22 to the closed state.

Step 522, OPEN VENT VALVE, may include the controller 16 sending a signal to the vent valve 30 effective to operate the vent valve 30 to the open state.

Step 524, OPERATE FIRST PUMP, may include the controller 16 outputting a first pump control signal (not shown) effective to operate the first pump 42.

Step 526, LEAK TEST PRESSURE ESTABLISHED?, may include the controller 16 monitoring the vacuum value 40 indicated by the vacuum sensor 38 until the EVAP system pressure is increased to a value suitable for leak testing the EVAP system 14. If NO, operation of the first pump is maintained until a suitable EVAP system pressure value is established. If YES, the method 500 proceeds to step 540.

Step 530, CLOSE VENT VALVE, may include the controller 16 sending a signal to the vent valve 30 effective to operate the vent valve 30 to the closed state.

Step 532, OPEN PURGE VALVE, may include the controller 16 sending a signal to the purge valve 22 effective to operate the purge valve 22 to the open state.

Step 534, OPERATE SECOND PUMP, may include the controller 16 outputting a second pump control signal (not shown) effective to operate the second pump 44.

Step 536, LEAK TEST PRESSURE ESTABLISHED?, may include the controller 16 monitoring the vacuum value 40 indicated by the vacuum sensor 38 until the EVAP system pressure is established at a value suitable for leak testing the EVAP system 14. If NO, operation of the second pump is maintained until a suitable EVAP system pressure value is established. If YES, the method 500 proceeds to step 540.

Step 540, CLOSE VENT VALVE AND PURGE VALVE, may include the controller 16 sending a signal to the vent valve 30 and the purge valve 22 effective to operate the vent valve 30 and the purge valve 22 to the closed state.

Once a suitable EVAP system pressure is established, the purge valve 22 and the vent valve 30 are both closed to effectively ‘seal’ the EVAP system 14 from the environment. Then the vacuum value 40 is monitored to determine if there is a leak in the EVAP system.

Step 545, WAIT LEAK TEST INTERVAL, may include the controller 16 starting a timer to time how long the EVAP system 14 is to be monitored for a leak. The method 500 may proceed to step 550 when the timer expires. Alternatively, the method 500 may proceed to step 550 if the vacuum value 40 changes my more than a predetermined amount. For example, if the EVAP system has a leak, the vacuum value 40 may change rapidly, and so the test is ended prematurely because the rapid change may indicate that a leak is present.

Step 550, DETERMINE ACTUAL EVAP SYSTEM PRESSURE CHANGE, may include determining a change of EVAP system pressure during the test interval, or determining a rate of change of EVAP system pressure during the test interval. The rate of change may be a maximum rate of changes during a period within the test interval, or an average rate of change over the entire test interval.

Step 555, DETERMINE FUEL CONSUMPTION, may include may include determining a change of fuel level in the fuel tank during the test interval, or determining a rate of fuel consumption during the test interval. The rate of fuel consumption may be determined by monitoring fuel injector operation of the engine 12 by the controller 16. The rate of fuel consumption may be a maximum rate during a period within the test interval, or an average rate over the entire test interval.

Step 560, COMPENSATE DIAGNOSTIC TEST, may include compensating the actual EVAP system pressure change determined in step 550 by adjusting that value based on the fuel consumption determine in step 555. By way of example and not limitation, fuel consumption is expected to reduce the EVAP system pressure during the test interval, but fuel heating and sloshing is expected to increase the EVAP system pressure during the test interval. If the actual EVAP system pressure change is not compensated for fuel consumption, a small increase in EVAP system pressure may be thought to indicate that no leak is present, but may actually be the result of fuel consumption offsetting the measured increase in EVAP system pressure, and thereby masking the leak.

Step 565, DETERMINE EXPECTED EVAP SYSTEM PRESSURE CHANGE, may include considering the duration of the test interval, ambient air temperature, fuel tank vibration or slosh, fuel formulation, fuel consumption, and other factors that may affect what the expected EVAP system pressure change should be.

Step 570, ACTUAL CHANGE=EXPECTED CHANGE±THRESHOLD?, may include determining if the actual change in EVAP system pressure and expected change in EVAP system pressure are within a percentage of each other, within ten percent (10%) for example. If, YES, i.e. the actual change corresponds with the expected change, then it is likely that no significant leak is present in the EVAP system 14. If NO, i.e. the actual change is, deepening on whether the test pressure was greater than or less than atmospheric pressure, much less than or much greater than the expected change, then it is likely that the EVAP system 14 has a leak, and so the method proceeds to step 575

Step 575, INDICATE LEAK DETECTED, may include activating a ‘check engine soon’ indicator, or logging the leak detection in the controller 16 for future use.

Accordingly, an EVAP system 14, and a methods 200, 300 and 400 of detecting a leak of an evaporative emissions system in a vehicle are provided. The methods are an improvement as they take into account the effects of fuel consumption on changes EVAP system pressure (i.e. fuel tank vacuum) during diagnostic testing of the EVAP system 14.

While this invention has been described in terms of the preferred embodiments thereof, it is not intended to be so limited, but rather only to the extent set forth in the claims that follow.

We claim:

1. A method for monitoring an evaporative emissions control (EVAP) system, said method comprising:
compensating a diagnostic test of the EVAP system based on a fuel consumption amount during a test interval.

2. The method in accordance with claim 1, wherein the step of compensating the diagnostic test includes
determining an actual pressure change of EVAP system pressure; and
determining an expected pressure change of EVAP system pressure, wherein the expected pressure change is determined based on vehicle operating conditions that include the fuel consumption amount.

3. The method in accordance with claim 2, wherein the method further comprises establishing a leak test pressure in the EVAP system; and
indicating that a leak is detected if the actual pressure change differs from the expected pressure change by more than a difference threshold.

4. The method in accordance with claim 2, wherein
the actual pressure change is based on a total pressure change during the test interval, and
the expected pressure change is based on a total fuel amount of fuel consumed during the test interval.

5. The method in accordance with claim 2, wherein
the actual pressure change is based on a pressure change rate during the test interval, and
the expected pressure change is based on a fuel consumption rate of fuel consumed during the test interval.

6. A method for monitoring an evaporative emissions control (EVAP) system in a vehicle, wherein said EVAP system includes a vent valve operable to an open state that allows fluidic communication through the vent valve between the fuel tank and atmospheric pressure, and a closed state that blocks fluidic communication through the vent valve; and a purge valve operable to an open state that allows fluidic communication through the purge valve between the fuel tank and engine vacuum, and a closed state that blocks fluidic communication through the purge valve, said method comprising:
establishing a leak test pressure in the EVAP system;
operating the vent valve and the purge valve to the closed state;
determining an actual pressure change of EVAP system pressure;
determining an expected pressure change of EVAP system pressure based on vehicle operating conditions that include the fuel consumption amount; and
indicating that a leak is detected if the actual pressure change differs from the expected pressure change by more than a difference threshold.

7. The method in accordance with claim 6, wherein the step of establishing a leak test pressure includes
operating the vent valve to the closed state and the purge valve to the open state, whereby the EVAP system pressure is reduced to a pressure less than atmospheric pressure.

8. The method in accordance with claim 6, wherein the EVAP system further comprises a first pump configured to pressurize the EVAP system to an EVAP system pressure greater than atmospheric pressure, wherein the step of establishing a leak test pressure includes
operating the first pump until the leak test pressure is established.

9. The method in accordance with claim 6, wherein the EVAP system further comprises a second pump configured to configured to reduce the EVAP system pressure to less than atmospheric pressure, wherein the step of establishing a leak test pressure includes
operating the second pump until the leak test pressure is established.

10. The method in accordance with claim 6, wherein
the actual pressure change is based on a total pressure change during a test interval, and
the expected pressure change is based on a total fuel amount of fuel consumed during the test interval.

11. The method in accordance with claim 6, wherein
the actual pressure change is based on a pressure change rate during a test interval, and
the expected pressure change is based on a fuel consumption rate of fuel consumed during the test interval.
